(19) United States
(12) Patent Application Publication
(10) Pub. No.: US 2025/0118776 A1
(43) Pub. Date: Apr. 10, 2025

(54) UNITIZED FUEL CELL

(71) Applicants: Hyundai Motor Company, Seoul (KR); Kia Corporation, Seoul (KR)

(72) Inventors: Yeong Hoon Jeong, Suwon-si (KR); Jong Hyeok Noh, Ansan-si (KR); Duk Hoon Kwon, Hwaseong-si (KR); Tak Heo, Suwon-si (KR); Jin Hyeok Yoo, Yongin-si (KR); Seung Hun Han, Osan-si (KR)

(21) Appl. No.: 18/412,947

(22) Filed: Jan. 15, 2024

(30) Foreign Application Priority Data
Oct. 4, 2023 (KR) 10-2023-0132001

(51) Int. Cl. H01M 8/0273; H01M 8/0258; H01M 8/2483

(52) U.S. Cl. CPC H01M 8/0273; H01M 8/0258; H01M 8/2483

(57) ABSTRACT

An embodiment unitized fuel cell includes a cell frame including an electricity generating assembly (EGA) bonded to a frame, the cell frame including a manifold hole disposed at an end part of the frame and a reaction gas guide part extending from the manifold hole, wherein the manifold hole is configured to allow a reaction gas to pass therethrough, and a pair of bipolar plates respectively laminated on both sides of the cell frame, the pair of bipolar plates including a first bipolar plate configured to form a flow path of the reaction gas together with the reaction gas guide part of the cell frame, the first bipolar plate having a recessed hole disposed on a part corresponding to the reaction gas guide part to expose a part of the reaction gas guide part therethrough and a second bipolar plate bonded to the cell frame.

### CROSS-REFERENCE TO RELATED APPLICATIONS

This application claims the benefit of Korean Patent Application No. 10-2023-0132001, filed on Oct. 4, 2023, which application is hereby incorporated herein by reference.

### TECHNICAL FIELD

The present disclosure relates to a unitized fuel cell.

### BACKGROUND

A fuel cell is a kind of power generation device, which converts chemical energy contained in fuel into electrical energy through an electrochemical reaction in a stack, and the fuel cell may be used to not only supply a driving power for industry, home, and vehicles but may also supply power to a small electronic product, such as a portable device, and recently, the usage area thereof has been gradually extended as a high-efficiency clean energy source.

A unit cell of a general fuel cell has a membrane-electrode assembly (MEA) positioned on an innermost side thereof, and the membrane-electrode assembly includes a polymer electrolyte membrane capable of moving protons and an anode and a cathode as electrodes disposed on both surfaces of the electrolyte membrane so that hydrogen and oxygen can react.

Further, a gas diffusion layer (GDL) is laminated on an outer part of the membrane-electrode assembly, that is, on an outer part where the anode and the cathode are positioned, and a bipolar plate on which a flow field is formed is positioned on the outer side of the gas diffusion layer so as to supply a fuel and to discharge water generated by the reaction.

A plurality of unit cells having the above-described configurations constitute a fuel cell stack through being laminated in series in order for the fuel cell to generate an output of a desired level. The fuel cell stack includes an end plate combined on the outermost side of the unit cells in order to support and fix the plurality of unit cells.

Meanwhile, in the related art, for sealing maintenance of the unit cells and convenience in a laminating process thereof, an electricity generating assembly (EGA) in which the membrane-electrode assembly and the gas diffusion layer are unitized may have been produced and used.

Further, research for a cell frame in which an EGA and a frame that supports the EGA are unitized and a bipolar plate is laminated on one side of the cell frame have recently been made.

The foregoing description of the background technology is intended merely to help the understanding of the background of embodiments of the present disclosure and is not intended to mean that embodiments of the present disclosure fall within the purview of the related art that is already known to those of ordinary skill in the art.

### SUMMARY

The present disclosure relates to a unitized fuel cell. Particular embodiments relate to a unitized fuel cell, which is easy to assemble and repair through unitization in one cell unit, and to a unitized fuel cell, which enables a cell frame and a bipolar plate to be effectively compressed in a unitization cell bonding process, in a state where a recessed hole is formed in a part corresponding to a guide part on one side of a bipolar plate that forms a flow path of a reaction gas together with the guide part of the cell frame, and a part of the guide part is exposed through the recessed hole, and which achieves the structural degree of freedom of the guide part.

Embodiments of the present disclosure provide a unitized fuel cell, which makes a cell frame and a bipolar plate be effectively laminated by making a uniform surface pressure act in a wider area in a unitized cell bonding process through removing a bipolar plate forming part, forming a recessed hole, and increasing a hot press pressurization area, and which secures the structural degree of freedom of a guide part of the cell frame by securing the degree of freedom of forming of support protrusions of the guide part of the cell frame.

The technical problems solvable by embodiments of the present disclosure are not limited to the above-mentioned technical problems, and it should be interpreted that other unmentioned technical problems will be able to be clearly understood by those of ordinary skill in the art to which the present disclosure pertains from the description of the embodiments of the present disclosure.

A unitized fuel cell according to an embodiment of the present disclosure may include a cell frame formed through bonding of an electricity generating assembly (EGA) and a frame, having a manifold hole formed at an end part of the frame and configured to make a reaction gas pass therethrough and having a reaction gas guide part formed to extend from the manifold hole, and a pair of bipolar plates laminated on both sides of the cell frame and including a first bipolar plate configured to form a flow path of the reaction gas together with the guide part of the cell frame and having a recessed hole formed on a part corresponding to the guide part on the first bipolar plate so as to expose a part of the guide part therethrough and a second bipolar plate bonded to the cell frame.

For example, a plurality of support protrusions extending in a direction in which the reaction gas flows and spaced apart from one another in a width direction are formed on the guide part of the cell frame, and flow paths through which the reaction gas flows are formed between the adjacent support protrusions.

For example, the first bipolar plate is supported by the support protrusions on the guide part, and the reaction gas flow path is formed through the adjacent support protrusions and the first bipolar plate.

For example, the plurality of support protrusions are covered by the first bipolar plate, and at least one of the support protrusions extends up to the manifold hole and is exposed through the recessed hole.

For example, a height of a point exposed through the recessed hole is higher than a height of a point covered by the bipolar plate.

For example, a difference in height between the point covered by the bipolar plate of the support protrusions and the exposed point is equal to a thickness of the bipolar plate.

For example, the plurality of support protrusions are covered by the first bipolar plate, and at least one of the support protrusions extends to a point spaced apart for a predetermined distance from the manifold hole and is exposed through the recessed hole.

For example, the plurality of support protrusions are all covered by the first bipolar plate.

For example, the plurality of support protrusions are covered by the first bipolar plate, at least two of the support protrusions extend toward the manifold hole, and a partition wall is formed between the adjacent support protrusions in the direction in which the reaction gas flows.

For example, the partition wall is formed at a point exposed through the recessed hole on the guide part.

For example, an inlet manifold hole and an outlet manifold hole are formed at both end parts of the frame, respectively, an inlet guide part is formed on the inlet manifold hole side, an outlet guide part is formed on the outlet manifold hole side, and a plurality of support protrusions are formed on the inlet guide part and the outlet guide part, respectively.

For example, the support protrusions of the inlet guide part and the support protrusions of the outlet guide part have different separation distances in a width direction.

For example, the support protrusions of the inlet guide part and the support protrusions of the outlet guide part have different widths at a point exposed by the recessed hole and at a point covered by the bipolar plate.

For example, on the outlet guide part, the plurality of support protrusions extend toward the manifold hole and are exposed through the recessed hole, and a partition wall is formed between the exposed points of the adjacent support protrusions along the direction in which the reaction gas flows.

For example, the frame is made of a plastic material.

For example, on the other surface directed toward the second bipolar plate of the frame, an inwardly recessed support groove is formed along the support protrusions at points corresponding to the support protrusions.

For example, a projection part is formed along the support protrusions on the second bipolar plate, and the projection part of the second bipolar plate is inserted into and supported by the support groove of the frame.

For example, the support groove and the projection part are shaped to extend along the support protrusions.

According to the unitized fuel cell of embodiments of the present disclosure, the cell frame and the bipolar plate can be effectively laminated by making the uniform surface pressure act in a wider area in the unitized cell bonding process through increasing the hot press pressurization area, and the structural degree of freedom of the guide part of the cell frame can be secured through securing of the degree of freedom of forming the support protrusions of the guide part of the cell frame.

Effects that can be obtained from embodiments of the present disclosure are not limited to the above-mentioned effects, and other unmentioned effects will be able to be clearly understood by those of ordinary skill in the art to which the present disclosure pertains from the following description of embodiments of the present disclosure.

### BRIEF DESCRIPTION OF THE DRAWINGS

The above and other objects, features, and advantages of embodiments of the present disclosure will be more clearly understood from the following detailed description taken in conjunction with the accompanying drawings, in which:

FIG. 1 is a plan view illustrating a part of a unitized fuel cell according to embodiments of the present disclosure;

FIG. 2 is a view illustrating one of various embodiments of a guide part of a unitized fuel cell according to embodiments of the present disclosure;

FIG. 3 is a cross-sectional view of a support protrusion of a guide part of a unitized fuel cell in a direction of line A-A′ in FIG. 1;

FIG. 4 is a cross-sectional view of a guide part of a unitized fuel cell in a direction of line B-B′ in FIG. 1;

FIGS. 5 to 8 are views illustrating various embodiments of a guide part of a unitized fuel cell of embodiments of the present disclosure; and

FIG. 9 is a view illustrating a shape in which unitized fuel cells of embodiments of the present disclosure are laminated.

### DETAILED DESCRIPTION OF ILLUSTRATIVE EMBODIMENTS

Hereinafter, embodiments disclosed in the description will be described in detail with reference to the accompanying drawings, and the same reference numerals are given to the same or similar constituent elements regardless of the figure number, and the duplicate explanation thereof will be omitted.

In explaining embodiments disclosed in the present specification, if it is determined that the detailed explanation of related known technology may obscure the gist of embodiments disclosed in the present specification, the detailed explanation will be omitted. Further, the accompanying drawings are merely to easily understand the embodiments disclosed in the present specification, and it should be understood that the technical idea disclosed in the present specification is not limited by the accompanying drawings, but includes all changes, equivalents, and substitutes included in the idea and technical scope of the present disclosure.

A singular expression includes a plural expression unless clearly defined in a different manner in context.

In the present specification, it should be understood that the term “include” or “have” specifies the presence of stated features, numerals, steps, operations, constituent elements, parts, or a combination thereof, but does not preclude the possibility of the presence or addition of one or more other features, numerals, steps, operations, constituent elements, parts, or a combination thereof.

Suffixes “module” and “part” for constituent elements as used in the following description are given or used interchangeably in consideration of only ease of preparation of the description and do not have distinguishable meanings or roles by themselves.

It should be understood that if a certain constituent element is mentioned to be “connected” or “coupled” to another constituent element, it should be understood that the certain constituent element is directly connected or coupled to the other constituent element and/or still another constituent element may exist in the middle. In contrast, if a certain constituent element is mentioned to be “directly connected” or “directly coupled” to another constituent element, it should be understood that the still another constituent element does not exist in the middle.

According to a unitized fuel cell of embodiments of the present disclosure, a bipolar plate forming part formed on a part corresponding to a guide part of a cell frame is removed, and a recessed hole is formed on a first bipolar plate that forms a flow path of a reaction gas together with the guide part. Further, in a unitized unit cell bonding process, a hot-press pressurization area is prevented from being decreased by preventing a loss of a guide part space, and a uniform surface pressure is made to act on a wider area. Accordingly, effective lamination of the cell frame and the bipolar plate becomes possible, and the bipolar plate forming part to be supported can be removed, so that the degree of freedom of forming guide part support protrusions of the cell frame can be secured, resulting in that the structural degree of freedom of the guide part of the cell frame can be secured.

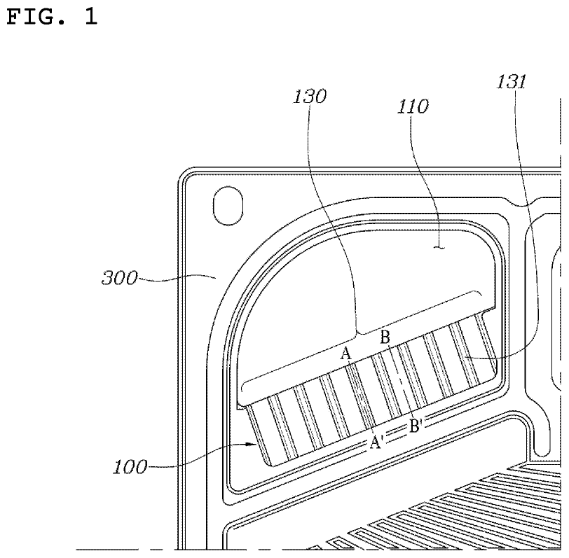

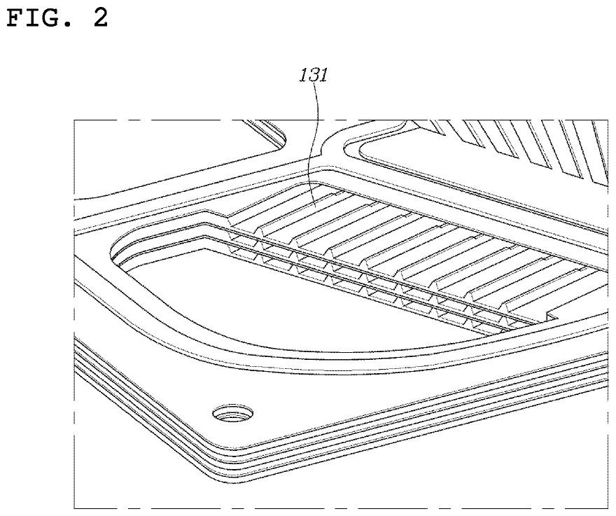

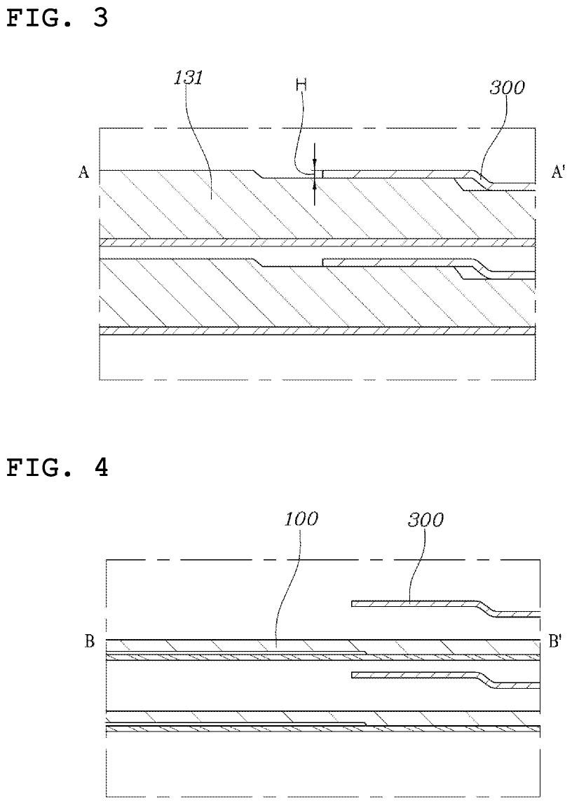

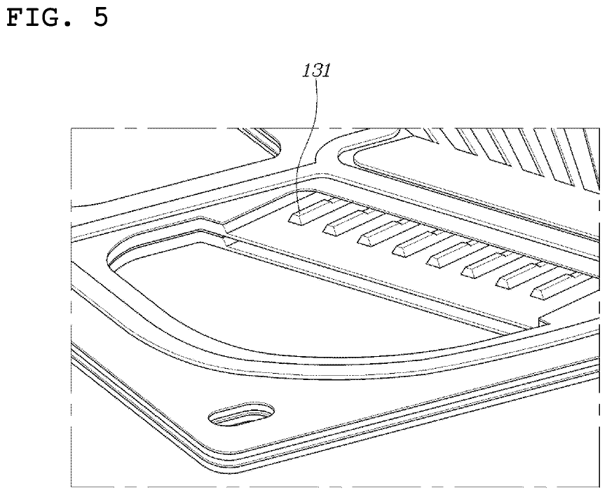

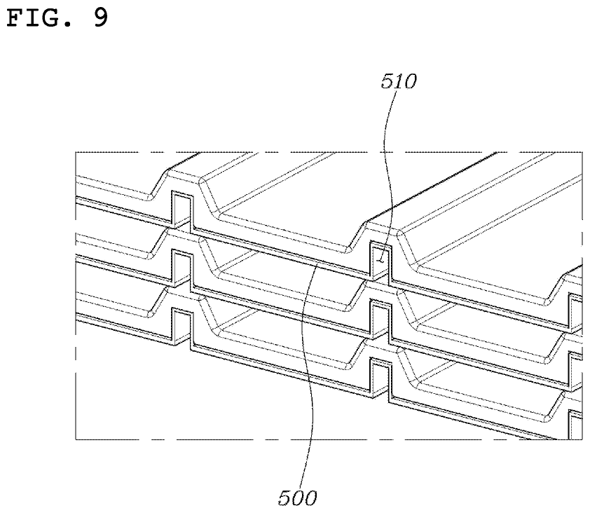

FIG. 1 is a plan view illustrating a part of a unitized fuel cell according to embodiments of the present disclosure, and FIG. 2 is a view illustrating one of various embodiments of a guide part of a unitized fuel cell according to embodiments of the present disclosure. FIG. 3 is a cross-sectional view of a support protrusion of a guide part of a unitized fuel cell in a direction of line A-A′ in FIG. 1, and FIG. 4 is a cross-sectional view of a guide part of a unitized fuel cell in a direction of line B-B′ in FIG. 1. FIGS. 5 to 8 are views illustrating various embodiments of a guide part of a unitized fuel cell of embodiments of the present disclosure, and FIG. 9 is a view illustrating a shape in which unitized fuel cells of embodiments of the present disclosure are laminated.

FIG. 1 is a plan view illustrating a part of a unitized fuel cell according to embodiments of the present disclosure. Referring to FIG. 1, a unitized fuel cell according to an embodiment of the present disclosure will be described.

According to a unitized fuel cell of embodiments of the present disclosure, a cell frame includes a manifold hole 110 formed at an end part of a frame and configured to make a reaction gas pass therethrough and a reaction gas guide part 130 formed to extend from the manifold hole 110, and a recessed hole is formed on a part corresponding to the guide part 130 on one side bipolar plate 300 configured to form a flow path of the reaction gas together with the guide part 130 of the cell frame so as to expose a part of the guide part 130 through the recessed hole.

According to the unitized fuel cell of embodiments of the present disclosure, the recessed hole is formed on the part corresponding to the guide part 130 on the one side bipolar plate 300 that forms the flow path of the reaction gas together with the guide part 130 of the cell frame, and a part of the guide part 130 is exposed through the recessed hole.

Through such a structure, a space loss due to the bipolar plate does not occur, and an alignment tolerance does not occur during manufacturing. Further, if the cell frame and the bipolar plate are manufactured through pressurization, a pressurization area is increased, and a uniform surface pressure can easily act on a wider area to facilitate effective lamination of the cell frame and the bipolar plate.

Further, since the diameter of the flow path can be increased as much as the thickness of the bipolar plate forming part (not illustrated), a fluid including the reaction gas and a reaction product can be stably exchanged between an inside and an outside of the cell frame.

Meanwhile, since a need for the support protrusions 131 of the frame to support the bipolar plate forming part (not illustrated) is decreased, limitations of the length, width, and interval of the support protrusions 131 of the guide part 130 are reduced, and a structure without any support protrusions 131 also becomes possible.

Further, by making the cell frame of plastic, it is possible to maintain the shape of the guide part 130 of the cell frame even without the bipolar plate forming part.

Further, through omission of the bipolar plate forming part (not illustrated) and change of the support protrusions 131, it is also possible to reduce the weight of the unitized fuel cell and to increase the energy density of a vehicle caused thereby.

FIG. 2 is a view illustrating one of various embodiments of a guide part of a unitized fuel cell according to embodiments of the present disclosure. FIG. 3 is a cross-sectional view of a support protrusion of a guide part of a unitized fuel cell in a direction of line A-A′ in FIG. 1, and FIG. 4 is a cross-sectional view of a guide part of a unitized fuel cell in a direction of line B-B′ of FIG. 1. FIGS. 5 to 8 are views illustrating various embodiments of a guide part of a unitized fuel cell of embodiments of the present disclosure.

Referring to FIGS. 2 to 8, the guide part 130 of the unitized fuel cell will be continuously described.

A plurality of support protrusions 131 extending in a direction in which the reaction gas flows and spaced apart from one another in a width direction are formed on the guide part 130 of the unitized fuel cell. Such support protrusions 131 are in a lip shape and extend up to a manifold hole 110. A flow path for fluid flowing therethrough is formed between the adjacent support protrusions 131.

The plurality of support protrusions 131 extending up to the manifold hole 110 may increase a structural stability of the guide part 130 and may also enable the fluid to be stably exchanged between the inside and the outside of the cell frame through the flow path formed between the adjacent support protrusions 131.

Referring to FIGS. 3 and 4, the flow path is formed by the adjacent support protrusions 131 formed on the guide part 130, and on the support protrusions 131, the height of a point exposed through the recessed hole is higher than the height of a point covered by the bipolar plate, and the difference in height between the two points is equal to the thickness of the bipolar plate.

Through such a structure, when unit cells of the unitized fuel cell are laminated to form a stack, the guide parts 130 of the respective unit cells of the unitized fuel cell are laminated through being supported by the support protrusions of the lower unit cells of the unitized fuel cell. Through this, the structural stability of the fuel cell stack is increased.

Further, since the fluid flowing through a specific flow path through the corresponding point of the support protrusion, which is covered by the bipolar plate, can be diffused to the both side adjacent flow paths, the fluid can smoothly flow between the inside and the outside of the cell frame.

FIGS. 5 to 8 correspond to various embodiments of the guide part 130 of a unitized fuel cell of embodiments of the present disclosure.

The plurality of support protrusions 131 of the guide part 130 of the unitized fuel cell of FIG. 5 extend up to a point that is spaced apart for a predetermined distance from the manifold hole 110 and are exposed through the recessed hole.

Through such a structure, the fluid space of the guide part 130 that exchanges the fluid with the inside of the cell frame through the manifold hole 110 of the guide part 130 is increased. Through this, the fluid can be smoothly exchanged with the manifold hole 110 through the guide part 130 of the cell frame.

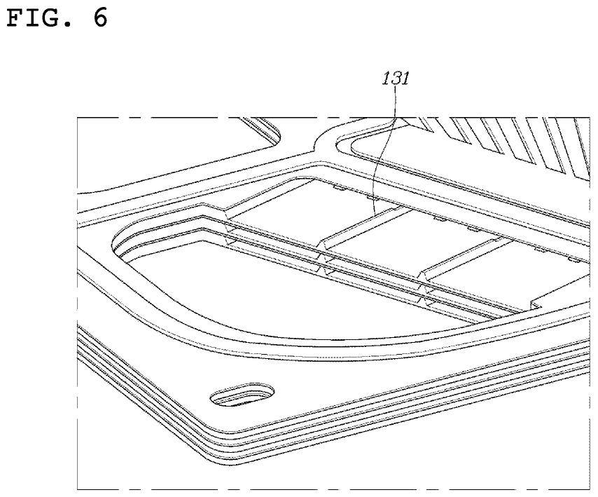

The plurality of support protrusions 131 of the guide part 130 of the unitized fuel cell of FIG. 6 are all covered by the one side bipolar plate, and a part of the guide part 130 exposed through the recessed hole forms a flat plate structure.

Through such a structure, a fluid space of the guide part 130 of the cell frame is increased, and the fluid can be smoothly exchanged between the inside of the cell frame and the manifold hole 110. Further, the support protrusions 131 are removed from the part of the guide part 130 that is exposed through the recessed hole, and thus the weight of the unitized fuel cell can be reduced as much as the corresponding weight.

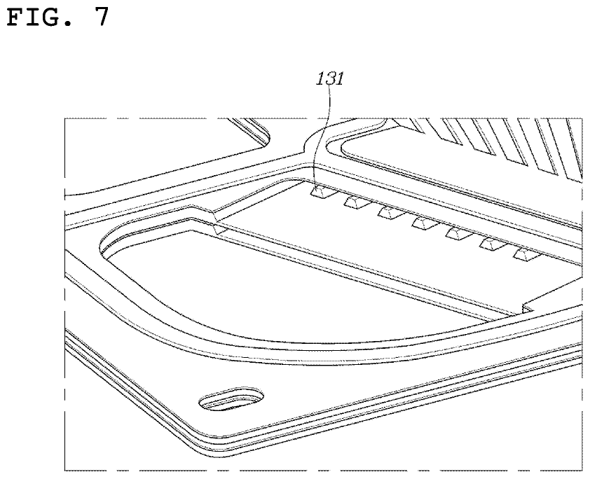

The plurality of support protrusions 131 of the guide part 130 of the unitized fuel cell of FIG. 7 have a structure in which the support protrusions 131, which are all covered by the one side bipolar plate 300, are formed between the support protrusions 131 extending up to the manifold hole 110. Through such a structure, on a part exposed through the recessed hole of the guide part 130, the support protrusions 131 extending up to the manifold hole 110 are spaced apart from each other at relatively wide intervals to form a flow path having a wide cross-sectional area. This causes the fluid space of the guide part 130 to be increased, causes the fluid to be smoothly exchanged with the manifold hole 110, and causes the support protrusions 131 extending up to the manifold hole 110 to support guide parts 130 of unit cells of other unitized fuel cells, thereby contributing to the structural stability of the unitized fuel cell stack.

Further, on a part of the guide part 130 that is covered by the one side bipolar plate 300, the support protrusions 131 extending up to the manifold hole 110 and the support protrusions 131 that are all covered by the one side bipolar plate 300 are spaced apart from each other at relatively narrow intervals to form a flow path having a narrow cross-sectional area. Since the exposed part and the part covered by the one side bipolar plate 300 have the same flow rate of the reaction gas introduced through the guide part 130, the reaction gas can be smoothly introduced into the cell frame at high speed through such a structure.

This is because in case that the same amount of fluid flows per unit time, the flow rate of the fluid that flows through the cross-sectional area per unit time is increased as the cross-sectional area becomes narrower, whereas the flow rate of the fluid that flows through the cross-sectional area per unit time is decreased as the cross-sectional area becomes wider.

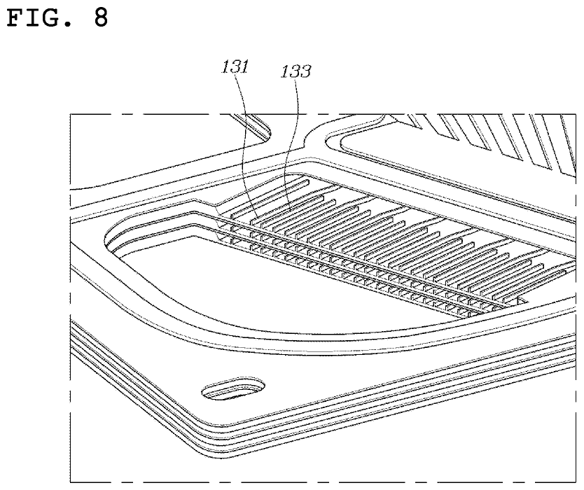

FIG. 8 illustrates one of various embodiments of a guide part 130 of a unitized fuel cell of embodiments of the present disclosure. Through this, the guide part 130 of the unitized fuel cell will be continuously described.

An inlet manifold hole 110 and an outlet manifold hole 110 are formed at both end parts of the frame, respectively, an inlet guide part 130 is formed on the side of the inlet manifold hole 110, and an outlet guide part 130 is formed on the side of the outlet manifold hole 110.

The support protrusions 131 of the inlet guide part 130 and the support protrusions 131 of the outlet guide part 130 may have different separation distances in a width direction and different widths of the support protrusions 131 themselves. Through this, the widths and the cross-sectional areas of the flow paths formed between the support protrusions 131 may differ from each other. Further, partition walls 133 may be formed between the adjacent support protrusions 131 to divide the flow path formed between the support protrusions 131, and the width and the cross-sectional area of the flow path may be adjusted more precisely by adjusting the number and the width of the partition walls 133.

Further, the support protrusions 131 of the inlet guide part 130 and the support protrusions 131 of the outlet guide part 130 may have different widths depending on the points.

Specifically, on the protrusion projections, the width of the point that is covered by the bipolar plate 300 may be relatively large, and the width of the point that is exposed through the recessed hole may be relatively small. Further, such changes of the widths may be continuous along the extension direction of the support protrusions.

Through such structures, if necessary, the widths of the flow paths located on the inlet guide part 130 and the outlet guide part 130 may differ from each other.

By speeding up the fluid that flows through the flow path through narrowing of the width of the flow path, the reaction products, such as water and the like, can be removed quickly, and by increasing the fluid space of the fluid through widening of the width of the flow path, smooth circulation of the reaction gas becomes possible. That is, if necessary, the flow rate of the fluid that flows through the flow path may be designed differently depending on the respective points, and thus the performance of the unitized fuel cell and the degree of freedom of the design can be increased.

FIG. 9 is a view illustrating a shape in which unitized fuel cells of embodiments of the present disclosure are laminated. Referring to FIG. 9, the unitized fuel cell of embodiments of the present disclosure will be described around the other side bipolar plate 500.

On one side of the frame, one side bipolar plate 300 formed with a recessed hole is laminated, and on the other side thereof, the other side bipolar plate 500 is laminated. On the other surface directed toward the other side bipolar plate 500 of the frame, an inwardly depressed support groove is formed along the support protrusions 131 at points corresponding to the support protrusions 131, and on the other side bipolar plate, a projection part 510 that is inserted into the support groove is formed along the support protrusions 131 on the other side bipolar plate. The support groove and the projection part 510 extend in a direction in which the reaction gas flows along the support protrusions 131.

Through such a structure, the other side bipolar plate 500 can effectively support the support protrusions 131 of the cell frame through the projection part 510. Through this, the structural stability of the guide part 130 of the cell frame, which may be reduced due to the removal of the bipolar plate forming part (not illustrated), can be reinforced, and the structural stability of the stack can also be reinforced through effective support of the unit cells of the adjacent unitized fuel cells during constitution of the unitized fuel cell stack.

The above-described detailed explanation should not be limitedly interpreted in all aspects, but should be considered as an example. The scope of the embodiments of the present disclosure should be determined by reasonable interpretation of the appended claims, and all changes in the equivalent scope of embodiments of the present disclosure are included in the scope of the embodiments of the present disclosure.

What is claimed is:

1. A unitized fuel cell comprising:
a cell frame comprising an electricity generating assembly (EGA) bonded to a frame, the cell frame comprising a manifold hole disposed at an end part of the frame and a reaction gas guide part extending from the manifold hole, wherein the manifold hole is configured to allow a reaction gas to pass therethrough; and
a pair of bipolar plates respectively laminated on both sides of the cell frame, the pair of bipolar plates comprising:
a first bipolar plate configured to form a flow path of the reaction gas together with the reaction gas guide part of the cell frame, the first bipolar plate having a recessed hole disposed on a part corresponding to the reaction gas guide part to expose a part of the reaction gas guide part therethrough; and
a second bipolar plate bonded to the cell frame.

2. The unitized fuel cell of claim 1, wherein:
a plurality of support protrusions extending in a direction in which the reaction gas flows and spaced apart from one another in a width direction are disposed on the reaction gas guide part of the cell frame; and
flow paths through which the reaction gas flows are defined between adjacent support protrusions of the plurality of support protrusions.

3. The unitized fuel cell of claim 2, wherein:
the first bipolar plate is supported by the support protrusions on the reaction gas guide part; and
the reaction gas flow path is defined through adjacent support protrusions of the plurality of support protrusions and the first bipolar plate.

4. The unitized fuel cell of claim 2, wherein:
the support protrusions are covered by the first bipolar plate; and
at least one support protrusion of the plurality of support protrusions extends up to the manifold hole and is exposed through the recessed hole.

5. The unitized fuel cell of claim 4, wherein a height of a point exposed through the recessed hole is higher than a height of a point covered by the first bipolar plate.

6. The unitized fuel cell of claim 5, wherein a difference in height between the point covered by the first bipolar plate and the point exposed through the recessed hole is equal to a thickness of the first bipolar plate.

7. The unitized fuel cell of claim 2, wherein:
the support protrusions are covered by the first bipolar plate; and
at least one support protrusion of the plurality of support protrusions extends to a point spaced apart for a predetermined distance from the manifold hole and is exposed through the recessed hole.

8. The unitized fuel cell of claim 2, wherein the support protrusions are all covered by the first bipolar plate.

9. The unitized fuel cell of claim 2, wherein:
the support protrusions are covered by the first bipolar plate;
at least two support protrusions of the plurality of support protrusions extend toward the manifold hole; and
a partition wall is disposed between adjacent support protrusions of the plurality of support protrusions in the direction in which the reaction gas flows.

10. The unitized fuel cell of claim 9, wherein the partition wall is disposed at a point exposed through the recessed hole on the reaction gas guide part.

11. The unitized fuel cell of claim 2, wherein:
an inlet manifold hole and an outlet manifold hole are disposed at both end parts of the frame, respectively;
an inlet guide part is disposed on an inlet manifold hole side;
an outlet guide part is disposed on an outlet manifold hole side; and
the plurality of support protrusions are disposed on the inlet guide part and the outlet guide part, respectively.

12. The unitized fuel cell of claim 11, wherein the support protrusions of the inlet guide part and the support protrusions of the outlet guide part have different separation distances in a width direction.

13. The unitized fuel cell of claim 11, wherein the support protrusions of the inlet guide part and the support protrusions of the outlet guide part have different widths at a point exposed by the recessed hole and at a point covered by the bipolar plates.

14. The unitized fuel cell of claim 11, wherein on the outlet guide part, the plurality of support protrusions extend toward the manifold hole and are exposed through the recessed hole, and a partition wall is disposed between exposed points of adjacent support protrusions of the plurality of support protrusions along the direction in which the reaction gas flows.

15. The unitized fuel cell of claim 1, wherein the frame comprises a plastic material.

16. A unitized fuel cell comprising:
a cell frame comprising an electricity generating assembly (EGA) bonded to a frame, the cell frame comprising a manifold hole disposed at an end part of the frame and a reaction gas guide part extending from the manifold hole, wherein the manifold hole is configured to allow a reaction gas to pass therethrough;
a plurality of support protrusions disposed on the reaction gas guide part of the cell frame, the support protrusions extending in a direction in which the reaction gas flows and spaced apart from one another in a width direction;
flow paths through which the reaction gas flows defined between adjacent support protrusions of the plurality of support protrusions; and
a pair of bipolar plates respectively laminated on both sides of the cell frame, the pair of bipolar plates comprising:
a first bipolar plate configured to form a flow path of the reaction gas together with the reaction gas guide part of the cell frame, the first bipolar plate having a recessed hole disposed on a part corresponding to the reaction gas guide part to expose a part of the reaction gas guide part therethrough; and
a second bipolar plate bonded to the cell frame, wherein on a second surface of the frame directed toward the second bipolar plate, an inwardly recessed support groove is disposed along the support protrusions at points corresponding to the support protrusions.

17. The unitized fuel cell of claim 16, wherein:
a projection part is disposed along the support protrusions on the second bipolar plate; and
the projection part of the second bipolar plate is inserted into and supported by the support groove of the frame.

18. The unitized fuel cell of claim 17, wherein the support groove and the projection part are shaped to extend along the support protrusions.

19. The unitized fuel cell of claim 16, wherein the frame comprises a plastic material.

20. The unitized fuel cell of claim 16, wherein:
an inlet manifold hole and an outlet manifold hole are disposed at both end parts of the frame, respectively;
an inlet guide part is disposed on an inlet manifold hole side;
an outlet guide part is disposed on an outlet manifold hole side; and
the plurality of support protrusions are disposed on the inlet guide part and the outlet guide part, respectively.
